(19) United States
(12) Patent Application Publication
(10) Pub. No.: US 2014/0214260 A1
(43) Pub. Date: Jul. 31, 2014

(54) Method and Device for an Assistance System in a Vehicle for Performing an Autonomous or Semi-Autonomous Driving Maneuver

(71) Applicants: Alfred Eckert, Mainz-Hechtsheim (DE); Ronald Bayer, Muehlheim/Main (DE); Stefan Lueke, Bad Homburg (DE); Bernd Piller, Dreieich (DE); Georg Halasy-Wimmer, Vaihingen Enz (DE)

(72) Inventors: Alfred Eckert, Mainz-Hechtsheim (DE); Ronald Bayer, Muehlheim/Main (DE); Stefan Lueke, Bad Homburg (DE); Bernd Piller, Dreieich (DE); Georg Halasy-Wimmer, Vaihingen Enz (DE)

(73) Assignee: Continental Teves AG & Co. oHG, Frankfurt (DE)

(21) Appl. No.: 14/241,164

(22) PCT Filed: Aug. 21, 2012
(86) PCT No.: PCT/DE2012/100246

§ 371 Date: Feb. 26, 2014

(30) Foreign Application Priority Data
Sep. 8, 2011 (DE) 10 2011 112 577.2

(51) Int. Cl. B62D 15/02

(52) U.S. Cl. CPC B62D 15/0285
USPC 701/28; 701/23

(57) ABSTRACT

The invention relates to a method and a device for an assistance system that serves to perform an autonomous or semi-autonomous driving maneuver of a vehicle, e.g., a parking assistance system in a vehicle, wherein by means of a camera system, image data are acquired from the surroundings of a vehicle and processed in order to perform the driving maneuver. At least one direction in which the vehicle moves when performing the driving maneuver is indicated by means of at least one light signal device.

The invention relates to a method and a device for an assistance system that serves to perform an autonomous or semi-autonomous driving maneuver of a vehicle, e.g., a parking assistance system in a vehicle.

Optical sensor systems, particularly cameras for covering the surroundings of the vehicle, have been increasingly used in vehicles for several years. By means of special electronic devices and software, these systems can take on various functions that assist the driver, which is why such systems are also called assistance systems or driver assistance systems. Some of these assistance systems are already capable of performing autonomous or semi-autonomous driving maneuvers, e.g., performing maneuvers in order to get into and/or out of parking spaces.

For example, a system for assisting the driver when he or she gets into a parking space is known from DE 10 2009 057 837 A1. In that case, the system serves to assist the driver when he or she gets into a parking area of a vehicle garage. The surroundings of the vehicle are covered by means of a camera system. The images of the surroundings are analyzed by means of an image analysis method in order to detect the garage entrance of the vehicle garage. After the detection of the garage entrance, the image of the surroundings is analyzed, by means of a mark recognition method, for at least one mark arranged on a back wall of the garage. After that, the position of the vehicle relative to the garage entrance and the mark is determined and control signals indicating steering angles required for steering the vehicle into the parking area are generated depending on the determined position of the vehicle.

The control signals may be indicated to the driver as steering advice or supplied to at least one control system in order to realize semi-automatic or fully automatic driving of the vehicle into the parking area.

For assistance systems for performing autonomous or semi-autonomous driving maneuvers, sensor systems capable of covering the complete surroundings of the vehicle (panoramic view (360°) around the vehicle) can be used nowadays. The output signals of these sensor systems, which are in the form of detected objects around the vehicle, can be used to perform driver assistance functions. Concerning this, DE 10 2006 036 933 A1 shows a method for generating an overall image from at least two overlapping individual images, wherein cameras arranged on a motor vehicle acquire the individual images and an image processing device puts the individual images together so that the overall image is formed.

Systems as described in DE 10 2006 036 933 A1 are also referred to as top view systems or omnidirectional camera systems. Top view systems typically comprise several (real) image acquisition cameras arranged in or on the vehicle. Image data are generated from various regions of the surroundings of the vehicle by means of said image acquisition cameras and then subjected to different transformations in an electronic image data processing device and a complex image of the complete surroundings of the vehicle is generated, whereby, e.g., a view of the surroundings of the vehicle from a perspective above the vehicle roof (bird's eye view) can be obtained, i.e., an image by a (virtual) camera above the vehicle is generated. The overall image can be continually displayed to the driver of the motor vehicle on a display device in order to, e.g., make shunting or parking maneuvers easier. It is also possible to process/analyze the overall-image data by means of assistance systems for performing autonomous and semi-autonomous driving maneuvers, e.g., for object detection or for the derivation of control commands, e.g., for the control of the vehicle steering gear, gas and brake(s).

However, the process responsibility of assistance systems that serve to perform autonomous or semi-autonomous driving maneuvers, e.g., maneuvers performed in order to get into or out of parking spaces, is especially high. In particular, other road users (e.g., passers-by) must not be endangered and the ego-vehicle or other vehicles must not be damaged. This must be ensured at any time during an autonomous or semi-autonomous driving maneuver.

It is thus the object of the invention to specify a method and a device for an assistance system for performing autonomous and semi-autonomous driving maneuvers, wherein it is ensured that the great demands made on the process responsibility of the assistance system are met and that particularly any danger to people, materials and the environment is largely ruled out.

This object is achieved by methods with the features according to claim 1 and by a device with the features according to claim 10. Advantageous realizations and further developments are the subject matter of subclaims, wherein combinations and further developments of individual features are also conceivable.

An essential idea of the invention consist in the following: If an assistance system is used that particularly uses a top view system to perform an autonomous or semi-autonomous driving maneuver and in which an overall image of the surroundings of the vehicle made up of several individual images is processed, at least one direction in which the vehicle moves when performing the autonomous or semi-autonomous driving maneuver is indicated by means of at least one light signal device, whereby passengers and other road users (in particular, people in the vicinity of the vehicle) can be informed about the direction of movement intended by the assistance system and/or about the exact movement trajectory (driving path) of the vehicle. By indicating the at least one direction of movement, accidents can be avoided or the potential of danger to people can be reduced. Particularly when employing the inventive method/when equipping the inventive device with a top view system, it is particularly advantageously possible to flexibly react to the respective situation in the surroundings and, e.g., to indicate the direction of movement of the vehicle only if and/or only where there are other road users because the complete surroundings of the vehicle is covered in an overall image.

The inventive method is preferably employed in an assistance system that serves to perform an autonomous or semi-autonomous driving maneuver of a vehicle.

In principle, an autonomous or semi-autonomous driving maneuver may be any vehicle driving maneuver in which one, several or all open-loop control and closed-loop control task(s) is/are taken on by the assistance system. Otherwise, i.e., when performing the driving maneuver manually, the driver has to take on these tasks. Thus, an autonomous or semi-autonomous driving maneuver may also be, in particular, a fully automated driving maneuver, which is performed when the driver is not in the vehicle. The inventive method is particularly employed in an assistance system that serves to perform an autonomous or semi-autonomous maneuver in order to get into or out of a parking space. In this case, a semi-autonomous driving maneuver may be a maneuver performed in order to get into and/or out of a parking space in which the assistance system takes on one or several closed-loop control and open-loop control task(s), e.g., the open-loop control and closed-loop control of the vehicle brake(s) and vehicle steering gear. In this case, an autonomous driving maneuver is preferably a driving maneuver in which the assistance system takes on all open-loop control and closed-loop control tasks that are necessary to move the vehicle from an actual position to a desired position (e.g., parking position), e.g., including the closed-loop control/open-loop control of vehicle acceleration (gas).

The assistance system in which the inventive method is employed preferably comprises a camera system. By means of this camera system, image data are generated from the surroundings of a vehicle and processed in order to perform the driving maneuver, wherein the image data are preferably generated by means of several cameras directed toward different regions of the surroundings of the vehicle. After that, the image data can be suitably processed by means of image processing devices in order to perform the driving maneuver, e.g., in such a manner that objects (such as other vehicles and obstacles) are detected from the image data, the distances to the detected objects are determined, the length and the depth of a parking space is calculated, and the necessary driving maneuver including the required steering angles are derived on the basis of this information. In addition to the camera system, further sensors (such as ultrasonic, radar, lidar, and laser sensors) may be used to detect objects and obstacles and to calculate the length and the depth of the parking space.

When the autonomous or semi-autonomous driving maneuver is performed, at least one direction in which the vehicle moves when performing the driving maneuver (also referred to as direction of movement in the following) is indicated, according to the invention, by means of at least one light signal device, wherein the direction of movement may be indicated prior to and/or during the driving maneuver, wherein the indicated direction may be the current and/or future direction of movement of the vehicle in each case. The light signal device may be one or several device(s) of any design, e.g., one or several light source(s) arranged on and/or in the vehicle and designed and connected to the camera system/to the assistance system such that they can indicate the direction of movement of the vehicle. Preferably, the at least one light signal device is not the direction indicator of the vehicle and/or the tail light or any light signal device provided in addition to said already existing components.

The at least one light signal device for indicating the direction of movement is preferably at least one strip light arranged on the vehicle and particularly comprising several individual light sources that are arranged next to each other, wherein, in order to indicate the direction of movement, the individual light sources can be driven such that a chaser light moving in the at least one direction in which the vehicle moves when performing the driving maneuver is generated. The strip light may be, e.g., a flat LED light comprising an oblong printed circuit board with a plurality of light-emitting diodes (LEDs) as well as a transparent lens cover and a housing, said LEDs being arranged next to each other along the length and being spaced apart from each other. For example, a strip light (the flat LED light) may be arranged on one side of the vehicle or one strip light (flat LED light) at a time may be arranged on each of the two sides of the vehicle, e.g., in the region of the vehicle doors or as underfloor lighting on the vehicle bottom, particularly in the region between the front axle and the rear axle of the vehicle. In a particular realization, one or several strip light(s) may be arranged in the passenger compartment of the vehicle, e.g., in the region of the frames of side windows, particularly on the window line above the door panel.

If the lights are driven appropriately, the current or future direction of movement of the vehicle can be indicated in the form of a chaser light, i.e., in the form of a moving (running) chain of lights. Thus, a driver who is not in his or her vehicle (e.g., when an autonomous or remote-controlled driving maneuver is performed) and/or other road users can be informed about the direction of movement of the vehicle, particularly about whether the vehicle is moving/is going to move forward or backward. If, for example, the light signal device indicates that the vehicle is going to move backward next, the environment can act prior to the actual driving maneuver of the vehicle so that the driving maneuver (e.g., a maneuver performed in order to get into or out of a parking space) will not have to be aborted on account of, e.g., the presence of people and/or obstacles on the driving path.

According to the invention, the at least one light signal device for indicating the direction of movement may also be at least one projection means arranged on the vehicle. By means of the projection means, the at least one direction in which the vehicle moves when performing the driving maneuver can be projected, e.g., onto the surface of the pavement, wherein the manner of projection may vary. For example, the direction of movement may be projected in the form of an arrow or a chaser light with the direction of arrow/running direction corresponding to the direction of movement, or in the form of, e.g., a linear movement trajectory indicating the trajectory intended for the driving maneuver (the intended driving path) along which the vehicle is moving. The projection means for indicating the direction of movement is preferably a laser. For example, depending on the design of the assistance system, one or several laser(s) may be arranged in the passenger compartment of the vehicle, behind one or several pane(s) in particular, and project the direction of movement onto the surface of the pavement through the respective pane.

In a particular realization, the at least one light signal device may be illuminated wheel rims and/or illuminated hub caps. In this case, the at least one light signal device may be designed as, e.g., a circular LED strip light, wherein the direction of movement of the vehicle may be indicated in the form of, e.g., a rotating chaser light with the direction of rotation corresponding to the direction of traffic.

In an advantageous realization, the at least one light signal device is used to indicate the at least one direction in which the vehicle moves during the autonomous or semi-autonomous driving maneuver and, in addition to that, to illuminate at least one region of the surroundings of the vehicle. The at least one illuminated region of the surroundings of the vehicle may be, e.g., a region in a garage or entrance, wherein illumination takes place in the particular event of the detection (on the basis of the image data of the camera system) of an illumination of one or several region(s) of the surroundings of the vehicle that is below a particular brightness threshold value.

The light signal device for illuminating the at least one region of the surroundings of the vehicle is preferably driven such that the relevant region(s) is/are specifically illuminated in order to compensate for dark regions in the surroundings of the vehicle and/or in order to maximize the contrast in the relevant regions.

The camera system of the assistance system is preferably a system in which individual images from various regions of the surroundings of the vehicle are acquired by means of several cameras and suitably transformed by means of image processing means in order to generate an overall image of the surroundings of the vehicle thereby. Thus, the camera system is preferably a top view system.

The overall image of the surroundings of the vehicle is preferably processed in the inventive method in order to perform the driving maneuver, i.e., particularly in order to calculate the open-loop control quantities and closed-loop control quantities for the driving maneuver. A particular advantage of this realization of the method consists in the fact that all regions in the surroundings of the vehicle may be examined (e.g., with respect to the presence of road users on the intended driving path) by means of the overall image of the surroundings of the vehicle and that the direction of movement of the vehicle may be indicated according to the inventive method, e.g., only if other road users are really present in the surroundings of the vehicle. Furthermore, in an advantageous realization of the inventive method, the direction of movement of the vehicle may be indicated only in that region of the surroundings of the vehicle (e.g., only on that side of the vehicle) where other road users are present, whereby it is possible, in this realization of the inventive method, to react to the situation in the surroundings more dynamically or more flexibly when performing an autonomous or semi-autonomous driving maneuver.

Preferably, the at least one direction in which the vehicle moves when performing the autonomous or semi-autonomous driving maneuver is only indicated if at least one other road user is detected in the overall image.

Furthermore, in a preferred embodiment of the inventive method, particularly in the event of the detection of one or several other road user(s) in the surroundings of the vehicle and particularly if several light signal devices are arranged on the vehicle, only those light signal devices for indicating the at least one direction which can be seen by the one or the several other road user(s) are driven, wherein light signal devices are preferably driven only on those sides of the vehicle where other road users have been detected.

The at least one direction of the vehicle indicated according to the invention is preferably one of the directions of traffic “forward” or “backward” and/or the current or future direction in which the vehicle moves when performing the driving maneuver.

The inventive device for indicating at least one direction of movement of a vehicle preferably comprises a camera system that acquires individual images from various regions of the surroundings of a vehicle by means of several cameras and suitably transforms said individual images by means of image processing means in order to generate an overall image of the surroundings of the vehicle thereby.

Furthermore, the device comprises at least one light signal device for indicating at least one direction of a movement that the vehicle performs during an autonomous or semi-autonomous driving maneuver, wherein, according to the invention, the device is designed such that the overall image of the surroundings of the vehicle is processed (e.g., by means of an appropriately designed (common) image data processing unit) in order to perform the autonomous or semi-autonomous driving maneuver of the vehicle and in order to indicate the at least one direction of movement of the vehicle.

1. A method for an assistance system that serves to perform an autonomous or semi-autonomous driving maneuver of a vehicle, particularly a maneuver performed in order to get into or out of a parking space, and in which, by camera system, image data are acquired from the surroundings of a vehicle and processed in order to perform the driving maneuver,
characterized in that
at least one direction in which the vehicle moves when performing the driving maneuver is indicated by at least one light signal device.

2. The method according to claim 1, characterized in that the light signal device is at least one strip light arranged on the vehicle and comprising several light sources that are arranged next to each other, wherein, in order to indicate the at least one direction, said light sources are driven such that a chaser light moving in the at least one direction is generated.

3. The method according to claim 1, characterized in that
the light signal device is at least one projection device arranged on the vehicle, wherein
the at least one direction is projected onto the surface of a pavement by the projection device.

4. The method according to claim 3, characterized in that
the projection device is a laser and
the at least one direction is projected, in the form of a movement trajectory, onto the surface of the pavement by the laser.

5. The method according to claim 1, characterized in that
the at least one direction is indicated by illuminated hub caps or of illuminated wheel rims.

6. The method according to claim 1, characterized in that
the at least one light signal device is additionally used to illuminate at least one region of the surroundings of the vehicle, particularly in garages and dark entrances.

7. The method according to claim 1, characterized in that
the camera system of the assistance system is a system in which individual images from various regions of the surroundings of the vehicle are acquired by several cameras and suitably transformed image processing devices in order to generate an overall image of the surroundings of the vehicle thereby, and
the overall image is processed in order to perform the driving maneuver.

8. The method according to claim 1, characterized in that
the at least one direction is only indicated if at least one other road user is detected in the image data.

9. The method according to claim 8, characterized in that
in the event of the detection of one or several road user(s), particularly if several light signal devices are arranged on the vehicle, only those light signal devices for indicating the at least one direction which can be seen by the one or the several road user(s) are driven.

10. A device for indicating at least one direction of movement of a vehicle comprising
a camera system that is configured and adapted to acquire individual images from various regions of the surroundings of a vehicle by several cameras and suitably transforms said individual images by image processing devices to generate an overall image of the surroundings of the vehicle thereby,
a light signal device that is configured and adapted to indicate at least one direction of a movement that the vehicle performs during an autonomous or semi-autonomous driving maneuver, wherein
the overall image of the surroundings of the vehicle is processed to perform the autonomous or semi-autonomous driving maneuver of the vehicle and to indicate the at least one direction of movement of the vehicle.

11. A method of carrying out an autonomous or semi-autonomous parking maneuver by which a motor vehicle moves into or out of a parking space, comprising:
using at least one electronic sensor, acquiring data from and indicative of surroundings in an environment outside of said motor vehicle including said parking space in said environment;
using a processor arrangement, processing said data to produce control information;
using a driver assistance system of said motor vehicle, receiving said control information, and dependent thereon controlling said motor vehicle autonomously or semi-autonomously to perform said parking maneuver in which said motor vehicle moves or will move in a movement direction including at least a forward or backward movement component to move said motor vehicle into or out of said parking space; and
using said driver assistance system, activating at least one light signal device provided on said motor vehicle to emit light into said environment outside of said motor vehicle, so that said light visually indicates, to at least one person in said environment, said movement direction including said forward or backward movement component in which said motor vehicle moves or will move when performing said parking maneuver.
